(19) United States
(12) Patent Application Publication
(10) Pub. No.: US 2020/0248818 A1
(43) Pub. Date: Aug. 6, 2020

(54) Hemispherical Poppet Valve For Rotary Screw Compressor Intake Valves

(71) Applicant: Walter R. Chapman, JR., Cleveland Heights, OH (US)

(72) Inventor: Walter R. Chapman, JR., Cleveland Heights, OH (US)

(21) Appl. No.: 16/263,119

(22) Filed: Jan. 31, 2019

(51) Int. Cl. F16K 1/54; F16K 15/02; F16K 31/122; F16K 1/12

(52) U.S. Cl. CPC F16K 1/54; F16K 1/126; F16K 31/1221; F16K 15/021

(57) ABSTRACT

A modulating intake valve having a low internal pressure drop used in conjunction with a gas compressor, including a valve body having a gas inlet and a gas outlet. A self modulating, hemispherical shaped poppet within the valve body moves closer or further from a valve seat to control the gas flow into the inlet and out of the outlet into the gas compressor. The hemispherical poppet valve functions as a check valve to close against the valve seat and prevent flow of gas and oil from the compressor through the valve body and out of the gas inlet. A modulating piston disposed in a cage located between the gas inlet and the gas outlet. A control gas inlet port opens into a passageway to direct control gas to a space between the piston and the cage set to move the piston and hemispherical poppet valve at a given pressure.

### FIELD OF INVENTION

The present invention relates generally to rotary screw type compressor systems, and, more specifically, the present invention relates to a high efficiency intake valve featuring a lower internal pressure drop.

### BACKGROUND OF INVENTION

Compressors are used in a wide variety of industrial and residential applications. Compressors are also used to inflate or otherwise impart a fluid force on an external object such as tires or pneumatic tools. It is always desirable that a compressor provide consistent and efficient operation to ensure that the particular application (e.g., pneumatic tools) functions properly. To that end, modulation of compressor inlet and outlet conditions can provide reliable and efficient compressor and system operation.

A typical rotary-screw gas compressor operates as follows. Note that all references to gas refers to all gasses i.e. methane, nitrogen, argon, helium, air, etc. Gas is drawn into the compressor housing by the screw elements within the housing through an inlet filter. The inlet filter prevents dirt and dust from entering the compressor housing with the incoming gas. Preventing the input of dirt and dust protects the screw elements which are very expensive and can be damaged. It's also important to filter the gas as a first step in making sure that the compressed gas is clean: all the dust that is drawn into the compressor housing will eventually end up in the compressed gas system.

Before the gas enters compressor housing, it passes through an intake valve or unloader valve. This valve opens and closes the gas supply to the screw elements. When the intake valve is open, the compressor is in the ‘loaded’ condition: it is actually compressing gas and pumping it into the compressed gas system. When the intake valve is closed, it shuts off the gas supply to the compressor elements: the motor and screw elements are turning but the compressor housing is not drawing any gas in and is not pumping any gas out to the system.

When the intake/unloader valve is open, the gas enters the compressor housing and flows across the screw elements located within the compressor housing. The screw elements work like a pump and compress the gas. During this process, oil is injected into the compressor housing and surrounds the screw elements. The oil is provided to cool the gas which gets very hot during compression and lubricates the bearings supporting the screw elements. The oil is also there for sealing off the clearances between the screws elements. The result is a mixture of compressed gas and compressor oil. This mixture leaves the compressor housing surrounding the screw elements through an exit pipe.

The mixture of compressed gas and oil is directed into a gas/oil separator tank. The oil can be separated from the compressed gas by centrifugal force. The remaining oil (mostly small droplets and oil mist) can be separated from the compressed gas by a separator element which appears to be a big filter.

The gas with oil flows through the separator element within the separator tank. The separator element separates the remaining oil from the compressed gas. The separated oil is collected at the bottom of the separator tank and is directed back to the compressor housing. The separated oil is hot and is cooled by an oil cooler. Finally, the oil flows through an oil filter which removes all the dirt and dust that has collected in the oil. The oil is now again injected into the compressor housing with the screw elements.

The now clean, compressed gas is almost ready to leave the compressor system. But first, it is passed through a minimum pressure valve having an independent check valve to prevent any back flow of the gas into the separator tank.

The minimum pressure valve is typically a spring-loaded valve that opens at a certain pressure, for example 4 bar. The minimum pressure valve ensures that there is always a minimum pressure inside the gas/oil separator. This minimum pressure is needed for the correct operation of the compressor (i.e., pumping the oil around).

The compressed gas is still very hot at this point, about 80 degrees Celsius. The compressed gas is sometimes cooled by an after cooler before it leaves for its intended use. The gas temperature after the cooler is typically about 25 to about 40 degrees Celsius.

Because of the cooling down of the gas, a lot of water vapor condenses against the inside of the after cooler. This water is carried with the compressed gas towards the outlet of the compressor system. For this reason, a water or condensate trap is usually provided to separate the water from the compressed gas. The water is drained away through a small hose.

The compressed gas now finally leaves the compressor system.

### SUMMARY OF THE INVENTION

According to an embodiment of the present invention, there is disclosed a modulating intake valve having a low internal pressure drop used in conjunction with a gas compressor. The modulating intake valve includes a valve body having a gas inlet and a gas outlet. A self modulating, hemispherical shaped poppet is within the valve body set to move closer or further from a valve seat to control the gas flow into the gas inlet and out of the gas outlet into the gas compressor. The hemispherical poppet valve also functions as a check valve to close against the valve seat and prevent back flow of gas and oil from the gas compressor through the valve body and out of the gas inlet. A modulating piston is disposed in a cage located between the gas inlet and the gas outlet. A control gas inlet port opens into a passageway that can direct control gas to a space between the piston and the cage set to move the piston and the hemispherical poppet valve at a given pressure.

According to a further embodiment of the present invention, there is disclosed a rotary-screw type, compressor system. The rotary-screw type, compressor system includes an inlet conduit through which gas is drawn through and directed into a rotary-screw type, compressor. An exit conduit is provided through which a mixture of compressed gas and oil is directed from the compressor to a separator tank for separating the mixture of compressed gas and oil from the compressor housing into separated oil and compressed gas. An oil return conduit directs the separated oil in the separator tank back to the rotary-screw type, compressor. An exhaust conduit directs the separated gas in the separator tank out of the rotary-screw type, compressor system. A control valve connected by a pressure line to the separator tank directs control gas to a modulating intake valve in response to the compressed gas in the separator tank. The modulating intake valve having a valve body with a gas inlet and a gas outlet and a low internal pressure drop to be used in conjunction with the rotary-screw type, gas compressor. The valve body including a self modulating, hemispherical shaped poppet valve set to move closer or further from a valve seat to control the gas flow into the gas inlet and out of the gas outlet into the gas compressor. The hemispherical poppet valve funsctions as a check valve to close against the valve seat and prevent back flow of gas and oil from gas compressor through the valve body and out of the gas inlet. A modulating piston is disposed in a cage located between the gas inlet and the gas outlet. A control gas inlet port opens into a passageway that can direct control gas to a space between the piston and the cage set to move the piston and the hemispherical poppet valve at a given pressure.

### BRIEF DESCRIPTION OF THE DRAWINGS

The structure, operation, and advantages of the present invention will become further apparent upon consideration of the following description taken in conjunction with the accompanying figures (Figures). The figures are intended to be illustrative, not limiting.

Certain elements in some of the figures may be omitted, or illustrated not-to-scale, for illustrative clarity. The cross-sectional views may be in the form of slices, or near-sighted cross-sectional views, omitting certain background lines which would otherwise be visible in a true cross-sectional view, for illustrative clarity.

Often, similar elements may be referred to by similar numbers in various figures (Figures) of the drawing, in which case typically the last two significant digits may be the same, the most significant digit being the number of the drawing figure (Figure).

FIG. 1 is a schematic line diagram of the location of a rotary screw compressor intake valve in relation to other systems it is intended for use in conjunction with, according to the present invention.

FIG. 2 is a three-dimensional view of the modulating intake valve incorporating a hemispherical poppet with a poppet style check valve in the open position, according to the present invention.

FIG. 3 is a side, cross sectional view through line 3-3 of the modulating intake valve incorporating a hemispherical poppet with a poppet style check valve, shown in FIG. 2, in the open position, according to the present invention.

FIG. 4 is a three-dimensional view of the modulating intake valve incorporating a hemispherical poppet with a poppet style check valve in the closed position, according to the present invention.

FIG. 5 is a side, cross sectional view through line 5-5 of the modulating intake valve with the hemispherical poppet, shown in FIG. 4, in the closed position, according to the present invention.

FIG. 6 is a side, cross sectional view through line 5-5 of the modulating intake valve with the hemispherical poppet, shown in FIG. 4, in the modulating position, according to the present invention.

FIG. 7 is a top, orthogonal three-dimensional view of the hemispherical poppet, according to the present invention.

FIG. 8 is a bottom, orthogonal three-dimensional view of the hemispherical poppet, according to the present invention.

FIG. 9 is a side view of the hemispherical poppet, according to the present invention.

FIG. 10 is an orthogonal cross-sectional view side view through line 10-10 of the hemispherical poppet shown in FIG. 9, according to the present invention.

### DETAILED DESCRIPTION OF THE PREFERRED EMBODIMENT

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

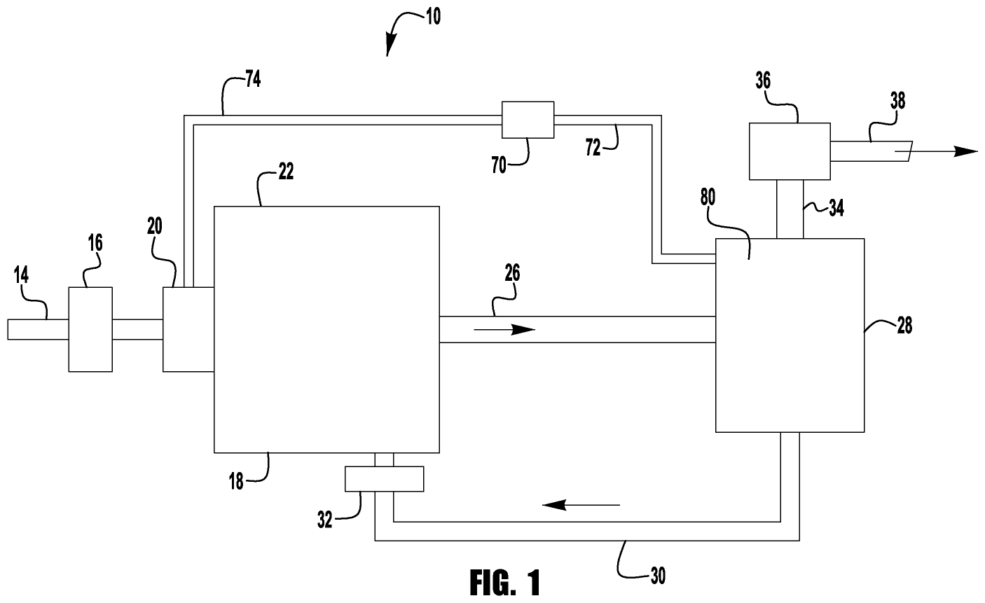

Referring to FIG. 1, there is illustrated a typical rotary-screw type, compressor system 10 incorporating an improved modulating intake valve 20 incorporating a hemispherical poppet which operates to modulate the gas flow into a compressor 18 as well as to provide a check valve to prevent gas and oil from flowing out of the compressor intake and into the surrounding atmosphere, according to the present invention.

This discussion of the present invention assumes a normally open control system for the compressor 18. The present invention would also apply to a normally closed control system for compressor 18.

The rotary-screw type, compressor system 10 includes an inlet conduit 14 through which gas, also called fluid herein, is drawn through and directed into a compressor 18 housing screw elements (not shown). An inlet filter 16 disposed in the inlet conduit 14 is provided to prevent dirt and dust from entering the compressor 18 with the incoming gas. Preventing the input of dirt and dust into the compressor 18 protects the screw elements which are very expensive and can be damaged. It's also important to filter the gas as a first step in making sure that the compressed gas is clean because all the dirt and dust that is drawn into the compressor 18 will eventually end up in the compressed gas system and be directed into the device using the compressed gas.

Before the gas enters the compressor 18, it passes through an intake valve 20 with a poppet style check valve. The intake valve 20 can be in use opened and closed and thereby regulates the gas supply through the inlet conduit 14 to the compressor 18. When the intake valve 20 is open, the compressor 18 is in the ‘loaded’ condition during which time it is actually compressing gas and pumping it through the compressor system 10. Also the intake valve 20 acts to modulate the flow of gas into the compressor in response to the amount of gas required. When the intake valve 20 is closed, it shuts off the gas supply to the compressor. That is, the motor and screw elements (not shown) are turning but the compressor 18 is not drawing any gas in through the inlet conduit 14 and is not pumping any compressed gas out of the compressor system 10.

When the intake valve 20 is open, the gas enters the compressor 18 and flows across the screw elements located within the compressor housing 22. The screw elements work as a pump and compress the gas. During this process, oil is injected into the compressor housing 22 and surrounds the screw elements. The oil is provided to cool the gas which gets very hot during compression. The oil is also there for lubrication of bearings and sealing off the clearances between the screw elements.

The result is a mixture of compressed gas and compressor oil, i.e. oily outlet gas, leaving the compressor housing 22 surrounding the screw elements through exit conduit 26.

The mixture of compressed gas and oil is directed through the exit conduit 26 and into a gas/oil separator tank 28. The separator tank 28 acts to separate the oil from the compressed gas by means, such as centrifugal force. The separated oil is collected at the bottom of the gas/oil separator 28 and is directed back to the compressor 18 through an oil return conduit 30. The separated oil is hot and can be cooled by an oil cooler 32 disposed in return conduit 30. Finally, the oil flows through an oil filter (not shown) which removes all the dirt and dust that has collected in the oil. The oil is now again injected into the compressor housing 22 with the screw elements.

The clean, compressed gas is directed from the gas/oil separator 28 through an exhaust conduit 34 and then through a minimum pressure valve 36. The minimum pressure valve 36 has an independent one-way valve (i.e. check valve, not shown) preventing gas from flowing back into the gas/oil separator and the compressor system 10.

The minimum pressure valve 36 is typically a spring-loaded, self-modulating back-pressure valve with an independent check valve that opens at a predetermined pressure, such as about 4 bar. The minimum pressure valve 36 ensures that there is always a minimum pressure inside the gas/oil separator 28. This minimum pressure is needed for the proper operation of the compressor 18, such as for pumping the oil around within the compressor housing 22. The compressed gas is still very hot at this point, for example about 80 degrees Celsius, and may be directed through an after cooler (not shown) to reduce the gas temperature, for example about 25 degrees to about 40 degrees Celsius. The compressed gas now passes through a conduit 38 to a desired location.

An important aspect of the present invention relates to increasing the efficiency and energy conservation in the compressor system 10 by providing a lower internal pressure drop in the intake valve 20 as compared with prior art intake valves used in conjunction with a comparable rotary screw compressor. The intake valve 20 opens at a defined pressure and controls the amount of gas going into the compressor 18. The intake valve includes a poppet style check valve 56 which is closed, as shown in FIG. 5, when no gas is required in the compressor 18. The intake valve 20 can be modulated to vary the amount of gas flowing into the intake end of the compressor 18. Also, the intake valve 20 can serve as an independent check valve to prevent pressurized gas from flowing out from intake end of the compressor 18 and into the inlet conduit 14 when the compressor is shut down.

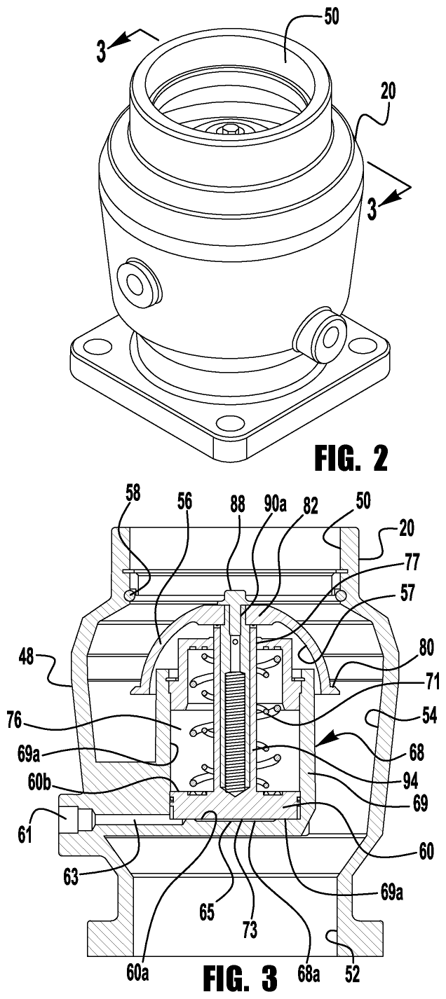

Referring to FIGS. 2 and 3, there is shown a three-dimensional view of the intake valve 20 with a poppet style check valve 56 in the fully open position, as best seen in FIG. 3. The intake valve 20 includes a valve body 48 with a gas inlet 50 and a gas outlet 52. The pressure drop through the intake valve 20 is lowered by having a smoothly flowing, fluid within the valve by shaping the interior walls 54 of the valve body 48 and the center structure 68 to reduce the pressure loss as the gas flows from the valve inlet 50 to the valve outlet 52.

The center structure 68, extends from an interior side wall 54 of the intake valve 20, and includes a cylindrical cage 69 to hold the piston 60, which reciprocates therein, and a cage closure member 75. The cage 69 has a bottom surface 69a with an indentation 73 depressed below the bottom surface of the cage. The cage closure member 75 is mounted within the outer end of the cage 69, opposite from the bottom surface 69a. The cage closure member 75 includes an aperture 77 therethrough to receive the cylindrical housing 94, which extends outward from the upper surface 60b of the piston 60.

A modulating spring 71 is disposed within the cage 69 about the cylindrical housing 94. One end of the modulating spring 71 is disposed within the cage closure member 75, and the other end of the spring engages the upper end 60b of the piston 60, so that the piston 60 is normally biased towards the bottom surface 69a of the cage 69. It must be noted that while the piston 60 does rest against the bottom surface 69a of the cage 69, there is an enclosed space 65 formed by the indentation 73 depressed below the bottom surface of the cage, and the bottom surface 60a of piston 60.

A hollow rod 90 is reciprocally received within a bore 92 through the center structure 68, and through the cylindrical housing 94 which is secured to and extends outward from the upper surface of piston 60. The hollow rod 90 can reciprocate in the bore 92 as the poppet valve 56 modulates the gas flow into the compressor 18. One end 90a of the rod 90 extends through a hemispherical shaped poppet 56, and is secured thereto with a screw 88 as described hereinafter.

Referring again to FIG. 3, the hemispherical shaped poppet 56 is moved closer or further from a valve seat 58 to control the gas flow into the compressor 18. To have a very high level of efficiency, the intake valve 20 should have a very low pressure drop when fully open. However, some compromise is required because the hemispherical poppet 56 must also act as a check valve, to prevent back flow of gas and oil from the compressor through the intake valve 20 when the compressor 18 is shutdown.

A bleed opening 95 is formed in the hollow rod 90 so that gas captured in the hollow rod is allowed to escape when the poppet style check valve 56 modulates.

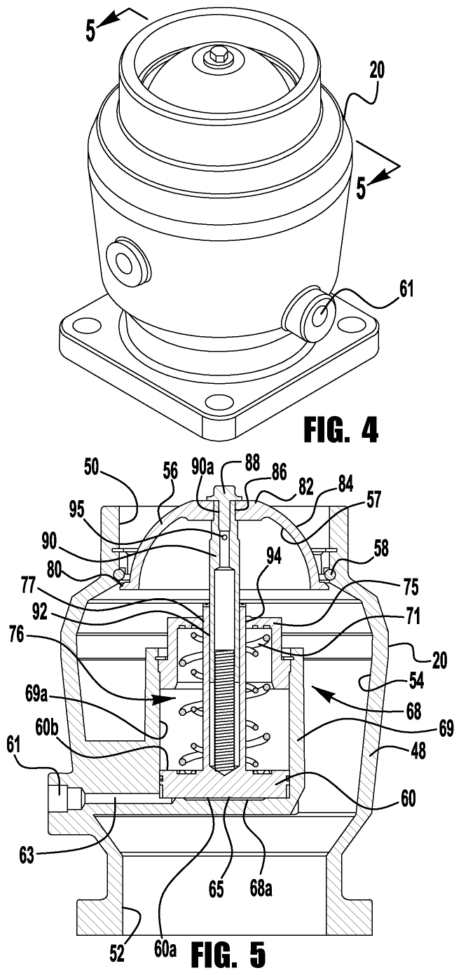

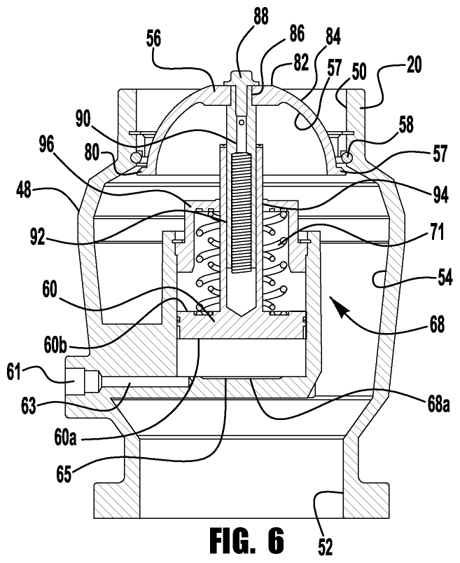

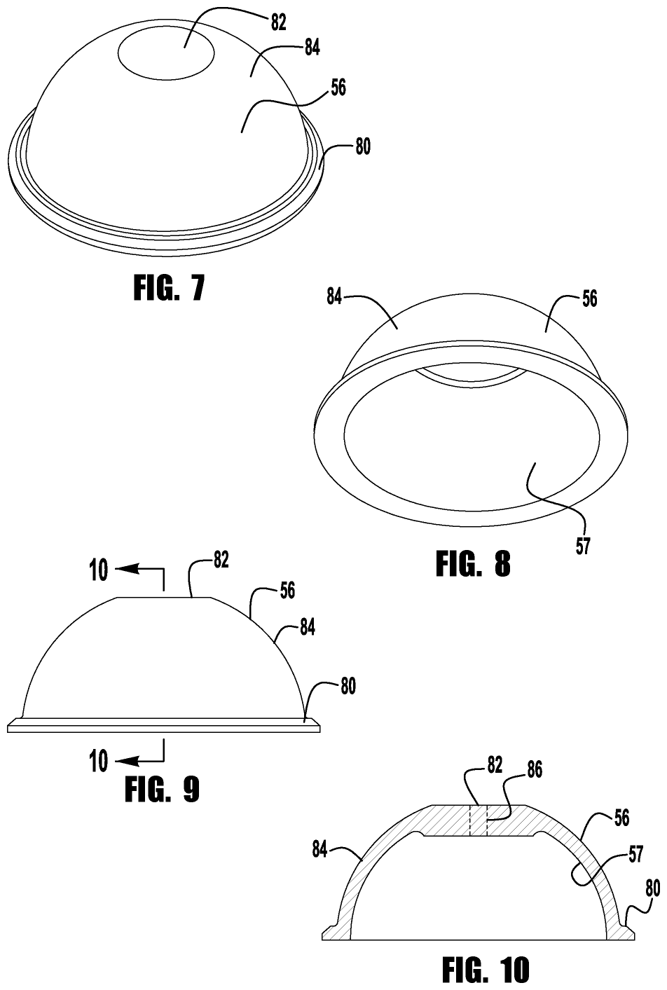

As shown in FIGS. 2-6, the valve body 48 incorporates a hemispherical poppet 56 and a piston 60 set to modulate at a given pressure. The piston 60, according to the present invention, modulates in a way that becomes evident upon contemplation of the orthogonal, cross-sectional, view of the piston 60 in FIGS. 3 and 6.

In FIG. 5, the poppet style check valve 56 is shown in a closed position against the valve seat 58. In this condition, the gas pressure of the gas in the compressor 18 acts against the inner surface 57 and causes the poppet valve 56 to be closed against the valve seat 58. In this state, gas would not flow though the valve inlet 50 to the inlet filter 16.

Referring again to FIGS. 2-6, the valve body 48 incorporates a control gas pilot port 61 which opens into a passageway 63 that can direct control gas to the space 65 between the bottom surface 60a of piston 60 and the opposing surface 68a of the cage 69.

At start up, the intake valve 20 is fully open with poppet style check valve 56 sitting on the seat 58. Once the screw elements start turning, the poppet style check valve 56 quickly opens. In this state, the compressor 18 is at full flow, building pressure in the system 10. As the pressure in the gas/oil tank 28 increases, the pressure in line 72 increases applying pressure to control valve 70.

The control pressure in the control gas pilot port 61 is directed by a control valve 70 which is connected by gas line 74. The control pressure in control valve 70 is delivered to the control gas pilot port 61 in the intake valve 20 through gas line 74. The control valve 70 is opened at a predetermined set pressure.

In this state, the intake valve 20 begins to modulate by application of control pressure to bottom surface 60a of the piston 60. The poppet style check valve 56 is driven toward the intake valve seat 58 (see FIG. 6) by piston 60. The pressure in the control valve 70 increases until the intake valve 20 is closed and the poppet 56 held against the seat 58 by the piston 60. In this state, the compressor 18 is at idle and no gas flows into the intake valve 20.

When the volume 65 between piston 60 and the cage 68 is not pressurized, gas flows through inlet 50, across the poppet valve 56, through the outlet 52 and into the compressor 18 which is operating to compress the gas being drawn in through the valve 20. The gas flowing through inlet 50 into the valve 20, causes the poppet valve 56 to move into the open position, as shown in FIG. 3, where the seal lip 80 is spaced from the seal 58. As the pressure in the gas/oil separator 28 changes, due to changes in the pressure being generated in the compressor, the pressurized gas in the control valve 70 causes the poppet valve 56 to move towards and away from the seat 58 to modulate the gas flow into the compressor.

The poppet valve 56 is shaped substantially as a hemisphere with a seal lip 80. The seal lip 80 can have a diameter sized to seal against a standard O-ring seal 58. The top surface 82 of the valve 56 can be flat as compared to the hemispherical shape of the outer side surface 84. The flat top surface 82 is primarily provided so that a passageway 86 can be provided through the top surface 82 of the valve to receive a screw 88 attached to a rod 90. Although the top surface 82 of the valve 56 is illustrated and described as flat, it is within the terms of the embodiment that the top surface be hemispherically shaped, as is the remainder of the valve. The rod 90 is received in a bore 92 through a housing 94 which is secured to and extends outward from the upper surface of piston 60. The rod 90 can reciprocate in the bore 92 as the poppet valve 56 modulates the gas flow into the compressor 18.

The poppet valve 56 would be in the open position, as shown in FIG. 3, when the device (not shown) connected to the compressor 18 is using the compressed gas. However, when the device being operated by the compressed gas generated by the compressor system 10 is not using the compressed gas, the pressure in the gas/oil separator 28 increases which in turn increases the pressure at the control valve 70. At a preset pressure, the control valve 70 is opened and high-pressure gas flows through gas line 74 to the control gas inlet port 61. With pressurized gas from the inlet port 61 flowing through passageway 63 into the space 65 between the piston 60 and the surface 68a of the cage 68, the piston 60 is biased into the position shown in FIG. 6.

At shutdown, the residual pressurized gas in the compressor 18 flows though the outlet opening 52 of the intake valve 20 and against the inner side surface 57 forcing the poppet valve 56 to close against the seat 58 so the oily gas from the compressor won't be discharged from the inlet 50 of valve 20 into the filter 16 and into the atmosphere.

Based on the previous discussion, it can be appreciated that the intake valve 20 of the rotary screw compressor is used to control the amount of gas going into the compressor. The intake valve 20 uses a poppet valve 56 to close the intake valve when no gas is required in the compressor. The intake valve can be modulated to allow varying amount of gas into the compressor when the latter is compressing gas. Also, the poppet valve 56 serves as the independent check valve. The poppet valve 56 is moved closer or further from valve seat 58 to control the gas flow through intake valve 20. To have the highest efficiency, the intake valve should have very low pressure drop when fully open. However, some compromise in the efficiency is required because a check valve is required to prevent back flow of gas and oil at compressor shutdown. The present invention lowers the full open pressure drop across the intake valve as compared to prior art designs.

In a typical example, the inlet pressure at the gas inlet 50 is atmospheric 14.7 pounds per square inch (psi) at the design flow and losses 4 inches of water pressure in the valve before gas outlet 52. In an intake valve similar to intake valve 20 but with the hemispherically shaped poppet valve 56 pressure loss thru the intake valve 20 is 3 inches of water. Therefore, there is an increased pressure which is used to operate a high-pressure device downstream from the compressor system gas outlet 38. With an increase in the outlet pressure, the compressor system 10 can operate more efficiently.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A modulating intake valve having a low internal pressure drop used in conjunction with a gas compressor, comprising:
a valve body having a gas inlet and a gas outlet;
a self modulating, hemispherical shaped poppet within the valve body set to move closer or further from a valve seat to control the gas flow into the gas inlet and out of the gas outlet into the gas compressor;
the hemispherical poppet valve also functioning as a check valve to close against the valve seat and prevent back flow of gas and oil from the gas compressor through the valve body and out of the gas inlet;
a modulating piston disposed in a cage located between the gas inlet and the gas outlet; and
a control gas inlet port which opens into a passageway that can direct control gas to a space between the piston and the cage set to move the piston and the hemispherical poppet valve at a given pressure.

2. The modulating intake valve of claim 1 wherein a center structure extends from an interior side wall of the pressure valve, includes a cage to hold the piston, which reciprocates therein, and a cage closure member.

3. The modulating intake valve of claim 2 wherein the cage has a bottom surface with an indentation depressed below the bottom surface of the cage.

4. The modulating intake valve of claim 3 wherein there is an enclosed space formed by the indentation depressed below the bottom surface of the cage, and the bottom surface of the piston.

5. The modulating intake valve of claim 4 wherein a cage closure member is mounted to the bottom surface of the cage and includes an aperture to receive a housing, which extends outward from an upper surface of the piston.

6. The modulating intake valve of claim 5 wherein one end of a modulating spring is disposed within the cage closure member, and the other end of the modulating spring engages an upper end of the piston so that the piston is normally biased towards the bottom surface of the cage.

7. The modulating intake valve of claim 6 wherein a hollow rod is reciprocally received within a bore through the center structure, and through a housing, which is secured to and extends outward from the upper surface of piston, whereby the rod can reciprocate in the bore as the poppet valve modulates gas flow into the gas compressor.

8. The modulating intake valve of claim 7 wherein a bleed opening is formed in the hollow rod so that gas captured in the hollow rod is allowed to escape when the poppet style check valve modulates.

9. The modulating intake valve of claim 8 wherein the poppet valve is shaped substantially as a hemisphere with a seal lip, wherein the seal lip is designed to seal against an O-ring seal.

10. The modulating intake valve of claim 9, further including a top surface of the poppet valve being flat as compared to the hemispherical shape of an outer side surface of the valve.

11. A rotary-screw type, compressor system, comprising:
an inlet conduit through which gas is drawn through and directed into a rotary-screw type, compressor;
an exit conduit through which a mixture of compressed gas and oil is directed from the compressor to a separator tank for separating the mixture of compressed gas and oil from the compressor housing into separated oil and compressed gas;
an oil return conduit for directing the separated oil in the separator tank back to the rotary-screw type, compressor;
an exhaust conduit for directing the separated gas in the separator tank out of the rotary-screw type, compressor system;
a control valve connected by a pressure line to the separator tank to direct control gas to a modulating intake valve in response to the compressed gas in the separator tank;
the modulating intake valve having a valve body with a gas inlet and a gas outlet and a low internal pressure drop to be used in conjunction with the rotary-screw type, gas compressor;
the valve body including a self modulating, hemispherical shaped poppet valve set to move closer or further from a valve seat to control the gas flow into the gas inlet and out of the gas outlet into the gas compressor;
the hemispherical poppet valve also functioning as a check valve to close against the valve seat and prevent back flow of gas and oil from gas compressor through the valve body and out of the gas inlet;
a modulating piston disposed in a cage located between the gas inlet and the gas outlet; and
a control gas inlet port which opens into a passageway that can direct control gas to a space between the piston and the cage set to move the piston and the hemispherical poppet valve at a given pressure.

12. The rotary-screw type, compressor system of claim 11 wherein a center structure extends from an interior side wall of the pressure valve, includes a cage to hold the piston, which reciprocates therein, and a cage closure member.

13. The rotary-screw type, compressor system of claim 12 wherein the cage has a bottom surface with an indentation depressed below the bottom surface of the cage.

14. The rotary-screw type, compressor system of claim 13 wherein there is an enclosed space formed by the indentation depressed below the bottom surface of the cage, and the bottom surface of the piston.

15. The rotary-screw type, compressor system of claim 14 wherein a cage closure member is mounted to the bottom surface of the cage and includes an aperture to receive a housing, which extends outward from an upper surface of the piston.

16. The rotary-screw type, compressor system of claim 15 wherein one end of a modulating spring is disposed within the cage closure member, and the other end of the modulating spring engages an upper end of the piston so that the piston is normally biased towards the bottom surface of the cage.

17. The rotary-screw type, compressor system of claim 16 wherein a hollow rod is reciprocally received within a bore through the center structure, and through a housing, which is secured to and extends outward from the upper surface of piston, whereby the rod can reciprocate in the bore as the poppet valve modulates gas flow into the gas compressor.

18. The rotary-screw type, compressor system of claim 17 wherein a bleed opening is formed in the hollow rod so that gas captured in the hollow rod is allowed to escape when the poppet style check valve modulates.

19. The rotary-screw type, compressor system of claim 18 wherein the poppet valve is shaped substantially as a hemisphere with a seal lip, wherein the seal lip is designed to seal against an O-ring seal.

20. The rotary-screw type, compressor system of claim 19, further including a top surface of the poppet valve being flat as compared to the hemispherical shape of an outer side surface of the valve.
